(19) United States
(12) Patent Application Publication
(10) Pub. No.: US 2010/0213192 A1
(43) Pub. Date: Aug. 26, 2010

(54) Plasma Treated Susceptor Films

(76) Inventors: Scott W. Middleton, Oshkosh, WI (US); Timothy H. Bohrer, Chicago, IL (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/709,578

(22) Filed: Feb. 22, 2010

Related U.S. Application Data
(60) Provisional application No. 61/208,379, filed on Feb. 23, 2009.

(51) Int. Cl. H05B 6/64; C08F 2/46

(52) U.S. Cl. 219/759; 427/488

(57) ABSTRACT

A microwave energy interactive structure comprises a polymer film having a pair of opposed sides, a first side of the pair of opposed sides being plasma treated, and a layer of microwave energy interactive material supported on the first side of the polymer film.

### CROSS-REFERENCE TO RELATED APPLICATION

This application claims the benefit of U.S. Provisional Application No. 61/208,379, filed Feb. 23, 2009, which is incorporated by reference in its entirety.

### BACKGROUND

It is known to use a susceptor in microwave heating packages for enhancing the browning and/or crisping of an adjacent food item. A susceptor is a thin layer of microwave energy interactive material, for example, aluminum, generally less than about 500 angstroms in thickness, for example, from about 60 to about 100 angstroms in thickness, and having an optical density of from about 0.15 to about 0.35, for example, about 0.17 to about 0.28. When exposed to microwave energy, the susceptor tends to absorb at least a portion of the microwave energy and convert it to thermal energy (i.e., heat) through resistive losses in the layer of microwave energy interactive material. The remaining microwave energy is either reflected by or transmitted through the susceptor.

The layer of microwave energy interactive material (i.e., susceptor) is typically supported on a polymer film to define a susceptor film. The susceptor film is typically joined (e.g., laminated) to a support layer, for example, paper or paperboard, using an adhesive or otherwise, to impart dimensional stability to the susceptor film and to protect the layer of metal from being damaged. The resulting structure may be referred to as a “susceptor structure”.

It is known that susceptor structures exhibit “self-limiting” behavior, that is, upon sufficient exposure to microwave energy, the susceptor film reaches a certain temperature and begins to form a crack or line of crazing. While not wishing to be bound by theory, it is believed that this crack or line of crazing propagates along a line of least electrical resistance through the conductive layer. As the crazing progresses and the cracks intersect one another, the network of intersecting lines subdivides the plane of the susceptor into progressively smaller conductive islands. As a result, the overall reflectance of the susceptor decreases, the overall transmission increases, and the amount of energy converted into sensible heat decreases.

This self-limiting behavior may be advantageous in particular heating applications where runaway heating of the susceptor would otherwise cause excessive charring or scorching of the food item and/or any supporting structures or substrates, for example, paper or paperboard. However, in other applications, it may desirable to limit or delay this behavior to ensure that the susceptor generates sufficient heat to be transferred to the adjacent food item to achieve the desired level of heating, browning, and/or crisping.

Accordingly, there remains a need for a greater understanding of the behavior of susceptor films. There further remains a need for susceptor films that exhibit the desired level of crazing, and therefore, desired level of heating for a particular application.

### SUMMARY

This disclosure is directed generally to a polymer film for use in a susceptor film, a method of making such a polymer film, and a susceptor film including the polymer film. The susceptor may be joined to a support layer to form a susceptor structure. The susceptor film and/or susceptor structure may be used to form countless microwave energy interactive structures, microwave heating packages, or other microwave energy interactive constructs.

According to one aspect of the disclosure, the topography of the polymer film may be tailored to control the rate and degree of crazing, and therefore, the self-limiting behavior, of a susceptor structure. More particularly, it is believed that in some cases, a smoother polymer film surface may provide greater heating longevity. In contrast, it is believed that in some cases, a rougher polymer film surface may accelerate the self-limiting behavior of the susceptor structure.

In some embodiments, the polymer film may be selected to have the desired surface characteristics for receiving the layer of microwave energy interactive material. Alternatively, the surface of the polymer film may be modified as needed prior to receiving the layer of microwave energy interactive material. The surface of the polymer film may be modified in any suitable manner, for example, using plasma treatment or any other technique capable of achieving the desired surface topography.

Other aspects, features, and embodiments will be apparent from the following description and accompanying figures.

### BRIEF DESCRIPTION OF THE DRAWINGS

FIG. 1 is a plot of pixel increase (increase in pizza crust browning) vs. PEL 120 roughness for the various plasma treated film samples; and

FIG. 2 is a plot of pixel increase (increase in pizza crust browning) vs. PEL 120 roughness for the various untreated and plasma film samples, with arrows connecting the data points for the corresponding untreated and treated sample pairs.

### DESCRIPTION

Although some attempts to understand the self-limiting behavior of susceptors have been made, the relationship between the surface characteristics of oriented films used for microwave susceptor films and the resulting susceptor performance has generally not been explored or understood.

Standard biaxially oriented, heat set polyethylene terephthalate (PET) films typically used to form susceptor films have strain-induced crystalline lamella surface structures. Such structures generally cause the surface of the film to be rough and/or irregular. In some cases, the peak to trough surface roughness may be from about 40 to about 100 nanometers or greater. Therefore, when microwave energy interactive material is deposited using vacuum vapor deposition onto the surface of the polymer film by line of sight travel from the metal source, it typically does not form a uniform layer. Instead, the microwave energy interactive material is non-uniformly deposited on the surface with some areas having more and some areas less or even no deposition of microwave energy interactive material. As a result, the conversion of microwave energy into sensible heat is likewise non-uniform.

While not wishing to be bound by theory, it is believed that complex resistive-capacitive circuits are formed in the conductive layer, with the areas completely or nearly void of conductive aluminum acting as capacitors. The routing of electrical current throughout the polymer film may be preferentially channeled to the paths (or circuits) of lowest resistance. The I²R power loss in low resistance circuits exceeds the power loss in immediately adjacent areas of higher resistance. As a result, low resistance circuits heat the biaxially oriented, heat set PET film above its glass transition temperature, and the resulting orientation stress relief causes a crack to form in the film.

According to one aspect of the invention, the surface characteristics of the polymer film may be selected and/or modified to alter the rate and degree of crazing of the susceptor film. For example, by reducing the strain induced crystalline lamella roughness associated with the surface of the PET film, a more uniform deposition of vapor deposited metal may be attained. A more uniform deposition may convert microwave energy to sensible heat more uniformly with fewer lines of crazing and a lower rate of craze formation. As a result, the peak temperature reached by the susceptor may increase while still retaining a desirable level of self-limiting behavior.

In one example, plasma treatment may be used to create a smoother surface for receiving the microwave energy interactive material. Plasma treatment generally consists of exposing a polymer to a low-temperature, low-pressure glow discharge. The resulting plasma is a partially ionized gas consisting of large concentrations of excited atomic, molecular, ionic, and free-radical species. Excitation of the gas molecules is accomplished by subjecting the gas, which is enclosed in a vacuum chamber, to an electric field, typically generated by the application of radio frequency (RF) energy. Free electrons gain energy from the imposed RF electric field, colliding with neutral gas molecules and transferring energy, dissociating the molecules to form numerous reactive species. It is the interaction of these excited species with films placed in the plasma that results in the chemical and physical modification of the film surface. More particularly, and while not wishing to be bound by theory, it is believed that the plasma treatment reduces the height of the crystalline lamella peaks on the surface of the film. Additionally, while not wishing to be bound by theory, it is also believed that the plasma treatment may cause a surface activation or chemical modification of the polymer film, which also may provide a more uniform deposition and a more uniform assembly of the crystalline structure of the microwave energy interactive material on the surface of the film. However, other treatments and methods for modifying the surface are contemplated.

In some embodiments, the plasma treatment (or other treatment) may reduce the roughness of the surface of the polymer film by at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, or any other amount. In other embodiments, the plasma treatment may reduce the roughness of the surface of the polymer film from about 10% to about 80%, from about 15% to about 60%, from about 20% to about 50%, from about 25% to about 35%, or any other range of amounts. In some particular examples, the plasma treatment may reduce the roughness of the surface of the polymer film about 26%, about 26.6%, about 32%, or about 32.3%.

It will be appreciated that there can be great variability in oriented films due to the large number of variables in the polymer, any additives, and process conditions by which the film is made. Some of such variables may include, but are not limited to, the presence of additives that influence the kinetics of crystallization, the achievable crystallinity of the polymer (including via modifications through incorporation of additives or co-monomers), the rate of orientation in the machine direction (MD) and transverse direction (TD), the degree of MD and TD orientation, the temperature, dwell time, and applied tension of heat setting, the temperature of orientation, the presence, concentration, and/or particle size of additives that increase surface roughness (e.g., anti-blocking agents) or any deposition of debris or particle contamination on the film surface prior to metal deposition, the presence of surface scratches or other defects resulting from the manufacturing process, and/or any other variable. Accordingly, each film may respond differently to plasma treatment (or other treatments) with varying degrees of smoothing; as with any chemical or mechanical process, one would logically expect to find conditions of overtreatment that generate effects opposite to those intended, with some undesirable combinations of film, plasma gas/gases, and applied power resulting in increased roughness. Likewise, the reduction in roughness of one film may result in a greater improvement in heating performance than another film.

To form the susceptor film according to one acceptable method, plasma treatment may be used to reduce the roughness of the surface of a polymer film, for example, a PET film. The basis weight and/or caliper of the polymer film may vary for each application. In some embodiments, the film may be from about 12 to about 50 microns thick, for example, from about 15 to about 35 microns thick, for example, about 20 microns thick. However, other calipers are contemplated.

The type of gas used and the plasma treatment conditions may vary for each application, depending on numerous factors, for example, the type of film being used, whether any additives are present, and so on, as discussed above. In some embodiments, the plasma treatment may be conducted using argon, nitrogen, carbon dioxide, helium, oxygen, air, fluorine, or any combination thereof. However, numerous other plasma treatment gases and mixtures thereof may be suitable. Likewise, any suitable treatment power level and other treatment conditions may be used. Suitable treatment power levels may vary by the gas or gases used and the specific polymer film being treated. Power levels above the optimum level for a particular combination of gas/gases and film may actually increase surface roughness through etching of portions of the film.

After plasma surface modification, a layer of microwave energy interactive material (i.e., a microwave susceptible coating or susceptor) may be deposited on the film to form a susceptor film. The microwave energy interactive material may be an electroconductive or semiconductive material, for example, a vacuum deposited metal or metal alloy, or a metallic ink, an organic ink, an inorganic ink, a metallic paste, an organic paste, an inorganic paste, or any combination thereof. Examples of metals and metal alloys that may be suitable include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide, for example, oxides of aluminum, iron, and tin, optionally used in conjunction with an electrically conductive material. Another metal oxide that may be suitable is indium tin oxide (ITO). Notably, ITO has a more uniform crystal structure and, therefore, is clear at most coating thicknesses.

Alternatively still, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

In other embodiments, the microwave energy interactive material may be carbon-based, for example, as disclosed in U.S. Pat. Nos. 4,943,456, 5,002,826, 5,118,747, and 5,410,135.

In still other embodiments, the microwave energy interactive material may interact with the magnetic portion of the electromagnetic energy in the microwave oven. Correctly chosen materials of this type can self-limit based on the loss of interaction when the Curie temperature of the material is reached. An example of such an interactive coating is described in U.S. Pat. No. 4,283,427.

If desired, the susceptor film may be laminated to another material to produce a susceptor structure for use in forming a microwave heating package or other construct. For example, the susceptor film may be laminated to a paper or paperboard support that may impart dimensional stability to the structure. The paper may have a basis weight of from about 15 to about 60 lb/ream (lb/3000 sq. ft.), for example, from about 20 to about 40 lb/ream, for example, about 25 lb/ream. The paperboard may have a basis weight of from about 60 to about 330 lb/ream, for example, from about 80 to about 140 lb/ream. The paperboard generally may have a thickness of from about 6 to about 30 mils, for example, from about 12 to about 28 mils. In one particular example, the paperboard has a thickness of about 14 mils. Any suitable paperboard may be used, for example, a solid bleached sulfate board, for example, Fortress® board, commercially available from International Paper Company, Memphis, Tenn., or solid unbleached sulfate board, such as SUS® board, commercially available from Graphic Packaging International, Marietta, Ga.

If desired, the susceptor film may be used in conjunction with other microwave energy interactive elements and/or structures. Structures including multiple susceptor layers are also contemplated. It will be appreciated that the use of the present susceptor film and/or structure with such elements and/or structures may provide enhanced results as compared with a conventional susceptor.

By way of example, the susceptor film may be used with a foil or high optical density evaporated material having a thickness sufficient to reflect a substantial portion of impinging microwave energy. Such elements typically are formed from a conductive, reflective metal or metal alloy, for example, aluminum, copper, or stainless steel, in the form of a solid “patch” generally having a thickness of from about 0.000285 inches to about 0.005 inches, for example, from about 0.0003 inches to about 0.003 inches. Other such elements may have a thickness of from about 0.00035 inches to about 0.002 inches, for example, 0.0016 inches.

In some cases, microwave energy reflecting (or reflective) elements may be used as shielding elements where the food item is prone to scorching or drying out during heating. In other cases, smaller microwave energy reflecting elements may be used to diffuse or lessen the intensity of microwave energy. One example of a material utilizing such microwave energy reflecting elements is commercially available from Graphic Packaging International, Inc. (Marietta, Ga.) under the trade name MicroRite® packaging material. In other examples, a plurality of microwave energy reflecting elements may be arranged to form a microwave energy distributing element to direct microwave energy to specific areas of the food item. If desired, the loops may be of a length that causes microwave energy to resonate, thereby enhancing the distribution effect. Microwave energy distributing elements are described in U.S. Pat. Nos. 6,204,492, 6,433,322, 6,552,315, and 6,677,563, each of which is incorporated by reference in its entirety.

In still another example, the susceptor film and/or structure may be used with or may be used to form a microwave energy interactive insulating material. Examples of such materials are provided in U.S. Pat. No. 7,019,271, U.S. Pat. No. 7,351,942, and U.S. Patent Application Publication No. 2008/0078759 A1, published Apr. 3, 2008, each of which is incorporated by reference herein in its entirety.

If desired, any of the numerous microwave energy interactive elements described herein or contemplated hereby may be substantially continuous, that is, without substantial breaks or interruptions, or may be discontinuous, for example, by including one or more breaks or apertures that transmit microwave energy. The breaks or apertures may extend through the entire structure, or only through one or more layers. The number, shape, size, and positioning of such breaks or apertures may vary for a particular application depending on the type of construct being formed, the food item to be heated therein or thereon, the desired degree of heating, browning, and/or crisping, whether direct exposure to microwave energy is needed or desired to attain uniform heating of the food item, the need for regulating the change in temperature of the food item through direct heating, and whether and to what extent there is a need for venting.

By way of illustration, a microwave energy interactive element may include one or more transparent areas to effect dielectric heating of the food item. However, where the microwave energy interactive element comprises a susceptor, such apertures decrease the total microwave energy interactive area, and therefore, decrease the amount of microwave energy interactive material available for heating, browning, and/or crisping the surface of the food item. Thus, the relative amounts of microwave energy interactive areas and microwave energy transparent areas must be balanced to attain the desired overall heating characteristics for the particular food item.

In some embodiments, one or more portions of the susceptor may be designed to be microwave energy inactive to ensure that the microwave energy is focused efficiently on the areas to be heated, browned, and/or crisped, rather than being lost to portions of the food item not intended to be browned and/or crisped or to the heating environment.

Additionally or alternatively, it may be beneficial to create one or more discontinuities or inactive regions to prevent overheating or charring of the food item and/or the construct including the susceptor. By way of example, the susceptor may incorporate one or more “fuse” elements that limit the propagation of cracks in the susceptor structure, and thereby control overheating, in areas of the susceptor structure where heat transfer to the food is low and the susceptor might tend to become too hot. The size and shape of the fuses may be varied as needed. Examples of susceptors including such fuses are provided, for example, in U.S. Pat. No. 5,412,187, U.S. Pat. No. 5,530,231, U.S. Patent Application Publication No. US 2008/0035634A1, published Feb. 14, 2008, and PCT Application Publication No. WO 2007/127371, published Nov. 8, 2007, each of which is incorporated by reference herein in its entirety.

In the case of a susceptor, any of such discontinuities or apertures may comprise a physical aperture or void in one or more layers or materials used to form the structure or construct, or may be a non-physical “aperture”. A non-physical aperture is a microwave energy transparent area that allows microwave energy to pass through the structure without an actual void or hole cut through the structure. Such areas may be formed by simply not applying microwave energy interactive material to the particular area, by removing microwave energy interactive material from the particular area, or by mechanically deactivating the particular area (rendering the area electrically discontinuous). Alternatively, the areas may be formed by chemically deactivating the microwave energy interactive material in the particular area, thereby transforming the microwave energy interactive material in the area into a substance that is transparent to microwave energy (i.e., microwave energy inactive). While both physical and non-physical apertures allow the food item to be heated directly by the microwave energy, a physical aperture also provides a venting function to allow steam or other vapors or liquid released from the food item to be carried away from the food item.

The present invention may be understood further by way of the following examples, which are not intended to be limiting in any manner. All of the information provided represents approximate values, unless otherwise specified.

### Example 1

Various films were plasma treated to determine the relationship between apparent surface roughness and browning performance, as set forth in Table 1. Samples 1, 2, 7, and 8 were Mylar® 800 PET film (DuPont Teijin Films™, Hopewell, Va.), samples 3 and 4 were Toray 10.12 PET (Toray Films Europe), samples 5 and 6 were Toray Lumirror® F65 PET (Toray Films Europe), and samples 9 and 10 were Terphane 19.88 (Terphane LTDA, San Paolo, Brazil). All of the samples were 48 gauge or about 12 microns thick.

The input power (about 6 kW) was applied over a 50 inch wide film at a processing speed of 2200 fpm, such that the resulting plasma energy was about 38 joules/sq. ft. The plasma treatment gas was supplied at about 1 to 2 psi. The plasma treatment equipment was of the type commercially available from Sigma Technologies International, Inc. (Tucson, Ariz.).

The apparent roughness of the surface (PEL) of each film was evaluated before and after treatment as follows. Images of the surface of the film were acquired using atomic force microscopy (AFM) at 0 to 100 nm full scale. A gray level histogram was generated using a gray scale from 0 to 256 units full scale light to dark using an image analysis system developed by Integrated Paper Services (IPS), Appleton, Wis. A binary image was produced at a gray scale of 120, which is equivalent to a plane intersecting the Z direction of the AFM image at 120/256*100 nm=46.9 nm or 469 angstroms in height. The perimeter of the detected region was measured and normalized by the linear size of the image to form a dimensionless ratio, perimeter divided by edge length, or PEL, with greater PEL values indicating a rougher surface. The results are presented in Table 1.

The films were then metallized with aluminum and joined to 14 pt (0.014 inches thick) Fortress® board (International Paper Company, Memphis, Tenn.) using from about 1 to about 2 lb/ream (as needed) Royal Hydra Fast-en® 20123 adhesive (Royal Adhesives, South Bend, Ind.) to form susceptor structures.

Each susceptor structure was then evaluated using a pizza browning test. A Kraft Digiorno pizza was heated on each susceptor structure for about 2.5 minutes in an about 1000 W microwave oven. When the heating cycle was complete, the food item was inverted and the side of the food item heated adjacent to the susceptor (i.e., the bottom of the pizza crust) was photographed. Adobe Photoshop was used to evaluate the images. An RGB (red/green/blue) setpoint of 104 was selected to correspond to a shade of brown generally associated with a browned, crisped food item. A tolerance of 100 was used. The number of pixels having that shade was recorded, such that a greater number of pixels indicated that more browning was present.

Prior to evaluating Sample 1 (control), the unheated pizza crust was examined to determine a baseline pixel count of 24313 pixels having the color associated with the RGB value 104. This baseline value was used to calculate the results presented in Table 1, where ΔUB is the number of pixels for a pizza crust heated on a given susceptor structure minus the baseline value for an unbrowned (UB) crust (24313), and %Δ PEL is the percent change in surface roughness between the treated and untreated sample as measured by PEL 120.

TABLE 1

| | | Plasma | | | % Δ | | |
|---|---|---|---|---|---|---|---|
| Sample/ | | treatment | Power | PEL | PEL | | |
| Structure | Polymer film | gas | (kW) | 120 | 120 | Pixels | ΔUB |
| 1 | Mylar ® 800 PET | None | None | 11.2 | n/a | 33566 | 9253 |
| 2 | Mylar ® 800 PET | Argon | 6 kw | 16.4 | 46.4 | 31747 | 7434 |
| 3 | Toray 10.12 PET | None | None | 6.37 | n/a | 28921 | 4608 |
| 4 | Toray 10.12 PET | Argon | 6 kw | 4.31 | −32.3 | 54517 | 30204 |
| 5 | Toray F65 PET | None | None | 12.6 | n/a | 37140 | 12827 |
| 6 | Toray F65 PET | Argon | 6 kw | 9.25 | −26.6 | 47469 | 23156 |
| 7 | Mylar ® 800 PET | None | None | 9.8 | n/a | 44401 | 20088 |
| 8 | Mylar ® 800 PET | Argon | 6 kw | 10.2 | 4.08 | 42812 | 18499 |
| 9 | Terphane 19.88 PET | None | None | 4.16 | n/a | 40788 | 16475 |
| 10 | Terphane 19.88 PET | Argon | 6 kw | 14.8 | 256 | 34031 | 9718 |

The results confirm that different polymer films will react differently to plasma treatment, with the different films tested separating themselves into two distinct response groups. Samples 3 and 5 (untreated Toray 10.12 and Toray F65) both responded to the plasma treatment to yield plasma treated Samples 4 and 6, respectively that showed reduced surface roughness and increased pizza crust browning compared to their untreated predecessors.

Untreated Samples 1 and 7 (DuPont Mylar® 800 PET film from different product lots) and untreated Sample 9 (Terphane 19.88) responded to the same plasma treatment applied to the other group (untreated Samples 3 and 5) to yield plasma treated Samples 2, 8 and 10, respectively that showed increased surface roughness and reduced pizza crust browning compared to their untreated counterparts.

These different responses occurred despite the films having different starting PEL 120 roughness; untreated Sample 9 had the lowest initial roughness and resulting treated Sample 10 had one of the highest treated film roughness values. On the other hand, untreated Sample 3, with the second lowest initial roughness responded to yield treated Sample 4, with the lowest absolute PEL surface roughness. Of the highest untreated film roughness samples, 1, 5 and 7, Samples 1 and 7's corresponding treated Samples 2 and 8 showed differing roughness increases while Sample 5's corresponding treated Sample 6 showed reduced roughness. Initial surface roughness of the untreated samples was not a determinant of the final surface roughness of the treated samples.

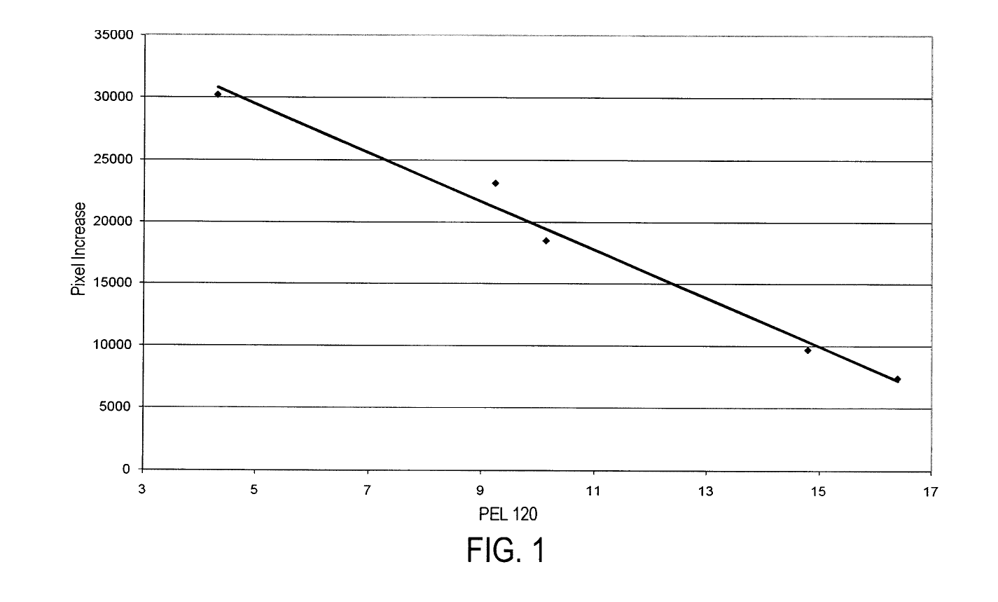

Sample 4, which had the lowest absolute PEL surface roughness value of all treated samples, also exhibited the best ability to provide pizza browning increases. In fact, a very strong correlation between surface roughness of plasma treated films and pizza crust browning capability became evident as the data was examined. FIG. 1 is a plot of pixel increase (increase in pizza crust browning) vs. PEL 120 roughness for the five plasma treated film samples (Samples 2, 4, 6, 8, and 10). These properties correlate at an r-squared coefficient of 98.5%.

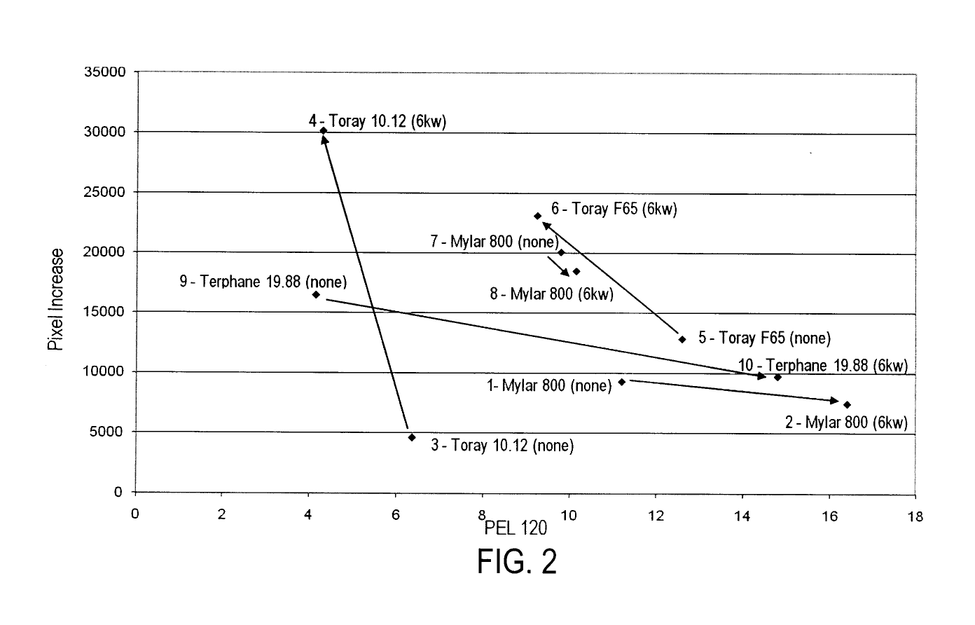

FIG. 2 includes the data points for the untreated film samples (Samples 1, 3, 5, 7, and 9), with arrows connecting the data points for the corresponding treated and untreated sample pairs. As stated above, starting roughness was not a determinant of final roughness, but the data points for all the treated films nonetheless fell on a line showing a linear inverse relationship between PEL 120 and pixel increase.

Without wishing to be bound by theory, it is believed that this data clearly show that pizza crust browning, a practical measure of the heating ability of a susceptor structure, is far more strongly related to surface smoothness for plasma treated films than for untreated films. This indicates that in addition to surface smoothing, the surface activation and/or chemical modification that occurs during a given plasma treatment acts to reduce differences in surface receptivity to susceptor deposition between different untreated films, yielding treated films for which their food heating capability can be predicted by surface roughness.

### Example 2

Samples of DuPont Mylar® 800 PET were exposed to plasmas under various conditions using nitrogen (N2) or a mixture of argon (Ar) and nitrogen as the plasma treatment gas, as set forth in Table 2. The input power (about 4 kW or about 6 kW) was applied over a 50 inch wide film at a processing speed of 2200 fpm, such that the resulting plasma energy was about 25 joules/sq. ft. or about 38 joules/sq. ft. Pizza browning testing was conducting as described in Example 1. The results are presented in Table 2, where %Δ Control is the change in pixel increase for a pizza heated on the given structure compared with the pixel increase for a pizza heated on control structure (Structure 1 from Example 1). PEL 120 data (surface roughness) was not available.

The results generally indicate that the optimum susceptor structure performance for susceptor films produced with plasma pretreatment will vary in terms of not only the chosen gas or gas mixture, but also with the applied power level of the plasma. The optimum combination of these process variables must be determined for each film grade by experimentation.

For example, for Mylar® 800 PET, a structure made with plasma treated film using nitrogen at 4 kW (Structure 11) outperformed both the control structure (Structure 1) and a structure made with plasma treated film using nitrogen at 6 kW (Structure 12). Structures 13 and 14, which were plasma treated using 80/20 mixture of argon and nitrogen showed a decrease in pizza browning. This is not surprising, given that one would expect an 80/20 mixture of argon and nitrogen to produce results that are similar to plasma treatment using only argon, which resulted in an increase in polymer film roughness and a decrease in pizza browning (see Samples/Structures 2 and 8 in Example 1).

TABLE 2

| | | Plasma | | | | |
|---|---|---|---|---|---|---|
| Sample/ | | treatment | Power | | | % Δ |
| Structure | Polymer film | gas | (kW) | Pixels | ΔUB | Control |
| 1 | Mylar ® 800 PET | None | None | 33566 | 9253 | n/a |
| 11 | Mylar ® 800 PET | N2 | 4 | 50561 | 26248 | 184 |
| 12 | Mylar ® 800 PET | N2 | 6 | 32100 | 7787 | −16 |
| 13 | Mylar ® 800 PET | 80/20 Ar/N2 | 4 | 25545 | 1232 | −87 |
| 14 | Mylar ® 800 PET | 80/20 Ar/N2 | 6 | 26347 | 2034 | −78 |

While the present invention is described herein in detail in relation to specific aspects and embodiments, it is to be understood that this detailed description is only illustrative and exemplary of the present invention and is made merely for purposes of providing a full and enabling disclosure of the present invention and to set forth the best mode of practicing the invention known to the inventors at the time the invention was made. The detailed description set forth herein is illustrative only and is not intended, nor is to be construed, to limit the present invention or otherwise to exclude any such other embodiments, adaptations, variations, modifications, and equivalent arrangements of the present invention. All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other. Further, various elements discussed with reference to the various embodiments may be interchanged to create entirely new embodiments coming within the scope of the present invention.

What is claimed is:

1. A method of making a microwave energy interactive structure, comprising:
plasma treating a polymer film, the polymer film having a surface roughness, whereby plasma treating reduces the surface roughness of the polymer film; and
depositing a layer of microwave energy interactive material onto the plasma treated polymer film, the layer of microwave energy interactive material being operative for converting at least a portion of impinging microwave energy into thermal energy.

2. The method of claim 1, wherein plasma treating the polymer film comprises
at least partially ionizing a plasma treatment gas, and
exposing the polymer film to the at least partially ionized treatment gas at a plasma treatment energy.

3. The method of claim 2, wherein the plasma treatment gas is selected from the group consisting of argon, nitrogen, carbon dioxide, helium, oxygen, air, fluorine, and any combination thereof.

4. The method of claim 2, wherein the plasma treatment gas comprises argon.

5. The method of claim 4, wherein the plasma treatment energy is about 38 joules/square foot.

6. The method of claim 2, wherein the plasma treatment gas comprises nitrogen.

7. The method of claim 6, wherein the plasma treatment energy is about 25 joules/square foot.

8. The method of claim 1, wherein the surface roughness of the polymer film is at least partially attributable to the height of surface lamella, and plasma treating the polymer film reduces the height of surface lamella.

9. The method of claim 1, wherein plasma treating the polymer film reduces the surface roughness of the polymer film about 20% to about 50%.

10. The method of claim 1, wherein plasma treating the polymer film reduces the surface roughness of the polymer film about 25% to about 35%.

11. The method of claim 1, further comprising joining a support layer to the layer of microwave energy interactive material such that the layer of microwave energy interactive material is disposed between the polymer film and the support layer.

12. The method of claim 11, wherein the support layer comprises paper, paperboard, or any combination thereof.

13. A microwave energy interactive structure comprising:
a polymer film having a pair of opposed sides, a first side of the pair of opposed sides being plasma treated; and
a layer of microwave energy interactive material supported on the first side of the polymer film, the layer of microwave energy interactive material being operative for converting at least a portion of impinging microwave energy into thermal energy.

14. The microwave energy interactive structure of claim 13, wherein the microwave energy interactive structure is operative for reaching a maximum temperature upon sufficient exposure to microwave energy, the maximum temperature of the microwave energy interactive structure being greater than a maximum temperature reached by a microwave energy interactive structure including a polymer film that is not plasma treated.

15. The microwave energy interactive structure of claim 13, wherein the layer of microwave energy interactive material has an optical density of from about 0.17 to about 0.28, the microwave energy interactive material comprising aluminum.

16. The microwave energy interactive structure of claim 13, wherein the polymer film comprises polyethylene terephthalate.

17. The microwave energy interactive structure of claim 16, wherein the polyethylene terephthalate is biaxially oriented.

18. The microwave energy interactive structure of claim 13, further comprising a support layer joined to the layer of microwave energy interactive material such that the layer of microwave energy interactive material is disposed between the polymer film and the support layer.

19. The microwave energy interactive structure of claim 18, wherein the support layer comprises paper, paperboard, or any combination thereof.

20. The microwave energy interactive structure of claim 13, comprising at least a portion of a microwave heating construct for heating, browning, and/or crisping a food item in a microwave oven.
